(19) United States
(12) Patent Application Publication
(10) Pub. No.: US 2024/0343144 A1
(43) Pub. Date: Oct. 17, 2024

(54) OPTIMIZED PV GENERATION SYSTEM

(71) Applicant: Frederick Johannes BRUWER, Paarl (ZA)

(72) Inventors: Frederick Johannes BRUWER, Paarl (ZA); Frederick Johannes BRUWER, JR., Paarl (ZA)

(21) Appl. No.: 18/637,495

(22) Filed: Apr. 17, 2024

(30) Foreign Application Priority Data
Apr. 17, 2023 (ZA) 2023/04445

(51) Int. Cl. B60L 53/51; H02J 7/35

(52) U.S. Cl. CPC B60L 53/51; H02J 7/35; B60L 2210/40; H02J 2300/26; H02J 2310/14

(57) ABSTRACT

A photovoltaic energy generation system which through the use of controlled switches a DC energy output from the system is used to deliver DC energy to a load, in particular to charge an electric vehicle, without using switch mode DC to DC, or DC to AC, converters.

### CROSS-REFERENCE TO RELATED APPLICATION

The present application claims priority from South Africa applications ZA 2023/04445, filed Apr. 17, 2023, the content of which is hereby incorporated by reference into this application.

### BACKGROUND

This invention relates to an energy generation system which is based on the use of photovoltaic (PV) panels and in one particular embodiment to charging at least one electric vehicle (EV) with the system.

An EV which is charged by a person at home is almost exclusively charged by means of an AC system. The cost of rapid charging DC systems is high in terms of infrastructure (high AC power supply requirements from the grid) and equipment cost.

A typical vehicle owner who uses an EV to commute to and from work often parks the EV at a work place for most of the day and at home for most of the night. If solar power is used to charge the EV at home battery storage which is expensive and not necessarily environmentally friendly is required. Alternatively an arrangement with a utility supplier is called for.

A PV system produces direct current (DC) that is converted to alternating current (AC) by an inverter. The AC is then supplied to the EV where it is inverted to DC by an onboard inverter. Electrical losses arise from energy storage in batteries and costs are incurred when high energy demands are placed on a supply grid. Consequently the charging of an EV at home using EV panels is inefficient and expensive.

Another factor to be considered is that hot water at a residence (home or hotel) is typically mostly used at night. If energy from a PV system is used to heat the water in the day an inverter, or an inverter with battery storage, is required for night use.

Batteries and inverters are expensive components. PV panels are however relatively low in cost. The invention is therefore concerned with a system which allows for the utilization of PV panels to supply DC power for energy usage while limiting the use, and hence the cost, of electronic circuitry.

### SUMMARY OF THE INVENTION

This invention has an objective to make charging of an EV directly from PV panels cost effective and especially targets office parking where an EV is parked most days of the week and for long hours (“office” is used generally to designate any work place). There are good prospects for a business model to bill for charging an EV during office hours from PV panels if the costs are low enough. The invention also targets the heating of water directly (i.e. without batteries or inverters) from PV panels and the optimization of energy supplied by PV panels.

Other uses of battery charging or energy storage applications are also contemplated but the invention is described primarily with reference to EV's and water heating, and wherein PV generated energy is used in other applications if an EV is not being charged, or if water is not being heated, or if not enough PV generated energy is available for more urgent energy usage. Although the heating of water is primarily discussed, the cooling or freezing of water or other fluid, using DC power is also applicable to this invention. The frozen substance (e.g. water or a water and glycol mix) can be used for air cooling in buildings.

Unlike a roadside charging station, there is very little time pressure for charging an EV if an office parking lot is utilized; similarly for the heating of water for a hotel or a home. Except for weekends an EV is probably parked in an office parking lot for most days and for most of the daylight hours per week. Similarly hot water is mostly used in a home or hotel during the evenings.

The extended parking time combined with the fact that PV panels produce DC power and EV batteries are ultimately charged with DC power, provide a basis to dramatically reduce equipment costs and hence charging costs through simplifications. The same is true if PV energy is stored in batteries to heat water in water heaters at night. A substantial cost saving can be effected if water is heated directly from PV panels during the day and then used directly, or as a feeder into a distributed geyser/water heater arrangement to replenish hot water which is used at night.

It is an objective of this invention to provide cost effective charging infrastructure for EV's in a typical situation which offers an extended parking period of several hours per day, and in a parking lot exposed to sunshine.

An electronic and electrical control unit is installed between an array of PV panels and at least one EV. A connector between the control unit and the EV is a standard connector as specified by relevant EV standards in the EU, the USA, Japan and other countries. The functions of the control unit are as follows:

The control unit determines if the connector is plugged into an EV and, if not plugged in, power is cut to the connector. This means no power is present at the connector when the connector is not plugged into an EV.

When the control unit is plugged into an EV and is charging, the control unit uses information from the EV or from a switch which is associated with the connector to determine when to interrupt the supply of power to the connector. This procedure is necessary so that the connector can be removed safely and without sparking from the EV.

At the start of the charging process after the connector is plugged into an EV, the control unit determines the operating parameters of the EV battery for example is it a 400V system or an 800V system.

The control unit then switches the PV panels into suitable arrays or configurations. For example, the PV panels can be configured and connected, by operation of the control unit, into two arrays each of which delivers \hat{ }400V. The arrays can then be switched via the control unit to have an output voltage of \hat{ }800V or in parallel to produce \hat{ }400V.

For example, four PV panels each of which is rated to produce 400V can be configured in any of the following arrays: 1×400V; 2×400V; 3×400V; 4×400V; 1×800V; 2×800V; 1×800V+1×400V; or 1×800V+2×400V using suitable configurations of power switches.

It is important that the power output from the PV panels and the control unit are substantially less than what the EV to be charged can accept for DC charging. This is in line with the minimum cost approach and the “enough time” available premise. An EV can be DC charged at a high Wattage level for example 100 kW, but the current invention targets a much lower charge Wattage level, for example of the order of 2 kW-10 kW despite the fact that the principles of the invention can be applied to much higher Wattage charging.

In a further cost efficiency construct the control unit is fitted with two or more connectors that allow the PV panels and control unit to charge two or more vehicles in adjacent parking bays, simultaneously. The control unit detects if one or two vehicles are plugged in. If a single EV is plugged in all the PV power is directed to the plugged in EV. If two vehicles are plugged in the power is split between the two vehicles and so forth.

If two EV's are connected the power split can be done on a time divisional basis or, if the EV charging voltage is compatible with an array of PV panels, each EV can be charged by a single PV array. For example, if the PV installation is in a configuration of 2×\hat{ }400V arrays and two 400V EV's are connected to the control unit, then the arrays can be connected in parallel whereby each EV is charged in a time slot because the EV battery levels or charging rates are not always the same, or each EV is separately connected to its own \hat{ }400V PV array.

To handle two \hat{ }800V EV's on the same basis whilst maintaining an ability to handle \hat{ }400V EV's as well, the PVs may be configured in 4×\hat{ }400V arrays.

An advantage of a dual EV charging arrangements that when only one EV is plugged in, all the PV power can be directed to the EV. It follows that when two EV's are plugged in the PV power is split between the two EV's.

The PV panels must be configured to have a voltage higher than the EV DC voltage. The standard available levels are between \hat{ }400V and \hat{ }800V. There are pros and cons to each level but this topic is not relevant to this invention. What is relevant is that all systems must be catered for in the design so the EV's can be charged at the lowest possible cost outlay.

If, for example, the system is designed to work with 400V, 600V and 800V battery voltage EV's then the PV panel array may be connected to an interface unit as 3×400V and 2×200V arrays. To get only 400V the 3×400V panels can be connected in parallel with series connected 2×200V panels. It will essentially be 4×400V arrays in parallel i.e. the Wattage delivered by one array times 4. This may be used to charge 4 EV's each with a \hat{ }400V battery each on a separate array, or with the arrays in parallel and using time divisional multiplexing to charge the individual EV's each in its own time slot. The arrays should be built with the same type of PV panels or provision must be made to use PV panels with compatible parameters, otherwise losses will be incurred.

Depending on the voltage specification for each PV panel the 400V arrays are made up of a number of PV panels in series. For example, if a 45V (maximum power point voltage) is used then 9 panels in series will give 405V i.e. the \hat{ }400V array.

Using the 3×400V and 2×200V arrays it is also possible to configure, through switching, to charge 600V and 800V EV's. It is understood, at present, that for EV's (not trucks) the standards are settling on \hat{ }400V and \hat{ }800V. The examples herein refer to these levels but such levels are not limiting.

The array voltages must be higher than the EV voltages because if the EV battery voltage is higher than the PV array voltage connected to it, no charging can occur. On the other hand, if the voltage from the PV array is 500V, and the EV requires 400V then the efficiency of the panels is lower as can clearly be seen from the I-V curves of PV panels.

For cost efficiency it is important to connect the minimum number of arrays. For example, if each individual panel is connected to an interface unit the cost for connectors, switches and wiring is unnecessarily increased.

The power extracted from PV panels is normally optimized by pulse width modulation switching (PWM) or MPPT (maximum power point tracking) algorithms, MPPT being more expensive. In this invention PWM can be used to alternately direct the PV power to a first EV or a second EV. This means the PWM technique can be more effective when charging two EV's than when used for charging a single EV.

Another cost-effective implementation is to control the current/voltage ratio through the battery characteristics. If the PV power does not approach the upper limit of the battery charging limits, the system controls itself, i.e. the current accepted by the battery is so high that it drives the PV voltage down to an equilibrium point on the PV panel I-V curve. This is valid until the battery goes from a bulk charging range into an absorption range, and further into a cut off range. The control unit may have to regulate the power from the PV panels with PWM or even switch off the power when the batteries are at a high charge level or the system may be set to disconnect the PV charging from the EV at that point. The control unit may determine these Voltage levels from settings, measurements or from communication with the EV.

The arrays of PV panels must be constructed to have an output (open circuit) voltage higher than the EV battery voltage when fully charged (for e.g. \hat{ }400V or \hat{ }800V). Because of the requirement that PV panels always provide less power than the EV batteries are allowed to be charged at, the current accepted for charging always pulls the PV voltage down to an equilibrium point. In essence the short circuit current of the connected PV array must always be below the maximum charging current of the EV and the open circuit voltage must be above the EV voltage.

The control unit may also condition the output voltage from the array of panels to be close to the voltage level required to charge the EV. For example, if 10 panels each with an open circuit (OC) voltage of 50V are connected in series then the total OC voltage=500V whilst the voltage when current is drawn may be in the 400V region. If it is undesirable to connect the 500V to the EV battery, even though it will immediately drop when current starts to flow, the control unit can be tasked to momentarily connect a dummy load to achieve the voltage drop before connecting the PV power to the connector and then removing the dummy load.

The control unit is also used to prevent any discharging from the EV, for example at night or when the sun is blocked by clouds.

The control unit may be constructed to feed into other DC loads, e.g. over weekends, for uses such as heating or cooling in order to save electricity whilst no vehicle is being charged. With regards to a liquid heating application the objective of the control unit is to apply DC power directly to a heating element that will heat the liquid (water or other fluid). Since the matching of the panels and the water heater/water heating element can be fixed at design time or installation time, the control unit is simplified.

In one embodiment the principal objective is to transfer PV generated energy to stored heat directly rather than converting through an inverter to store the energy in batteries. However, PV energy stored in batteries is the most generally usable form of energy storage, i.e. it can be used (in conjunction with an inverter) to power any normal appliance working on a mains power grid.

It is therefore an objective, in one embodiment to enable the use of more PV panels than what normally would be usable within an inverter specification. For example, in early morning or late afternoon when the PV energy is lower than in the middle of the day, additional PV panels may be added to supply the inverter. However, when the PV energy starts to exceed the PV input specifications of the inverter, some PV energy is switched to heat (or cool) the water.

Such an implementation has the advantage of optimizing the supply of the PV energy to the inverter (i.e. supplying more power to the inverter for longer periods of the day) and of using more PV panels in relation to inverters and batteries.

In a further embodiment the control unit switches an optimal array of PV panels to charge EV's. Any panels not used are combined and fed to an inverter system or MPPT for regular usage to charge batteries or to provide power to a concern. This may be together with other PV panels. This also allows the PV panels' energy to be gainfully used when, for example, no PV is plugged in for charging as is typically the case over weekends.

In a further embodiment the control unit may direct power from the EV's batteries to an inverter system i.e. the EV batteries are used for energy storage to allow for business or home usage during grid down time or for peak shedding purposes.

In an embodiment of the invention the control unit is fitted with a general communications module whereby the control unit can be directed from an energy management center to stop charging EV's and to route the power to an inverter system or batteries that support mains power for a facility. This may especially be useful at times of grid failure or at periods when peak tariffs become applicable.

If a DC to AC converter is used inside the control unit to charge EV's with AC, then this AC may also be routed to a structure at certain times to augment the supply of AC to the structure.

The control unit may also comprise sensors to monitor PV parameters and status, (Volts, Amps), temperature (to prevent operating temperatures which are too high), power meters, current meters, coulomb counters etc. for reporting performance and charging information.

If other standards evolve over and above the 400V and 800V battery systems, then such standards can be accommodated in accordance with the principles of this invention. As stated, references to 400V and 800V systems herein are exemplary, and non-limiting.

The invention thus provides a method of generating direct current (DC) energy for at least one DC load by using at least one array of PV panels that are connected to a control unit comprising a switch arrangement, including the step of using the control unit to configure the PV panels to generate a DC voltage and current output which is supplied to the at least one DC load, without requiring DC to DC (switch mode) converters or DC to AC converters in said control unit or in a circuit connected to the at least one DC load.

In one embodiment the control unit is also connected to an normal inverter input (MPPT) wherein the method includes the step of dynamically switching the PV panels in a configuration to provide maximum power to the inverter based on the inverter specification, and to switch the PV panels with excess energy supply, disconnected from the inverter at any time, to the at least one DC load. Further, in a variation, energy generated by the PV panels is used to power at least one water heating element and the method includes the step of using the control unit to operate the switch arrangement to configure at least one array of the PV panels, that meets the voltage and current requirements for powering the said at least one water heating element.

The invention extends to apparatus for generating direct current (DC) electrical power comprising at least one array of PV panels, a control unit and a switch arrangement connected to the PV panels and wherein the control unit is actuable to control the switch arrangement to configure the PV panels to control the DC voltage and current output from the PV panels, which output is connected to at least one DC electrical load, without requiring switch mode DC to DC or DC to AC converters in the control unit or in a circuit which is connected to the at least one DC load. The control unit may be connected to a normal inverter input (MPPT) and the control unit is actuable to control the switch arrangement to dynamically switch the PV panels in configurations to provide maximum power to the inverter, based on the inverter specification, and to disconnect the energy supply to the inverter at any time, and to switch the PV panels with excess energy supply to power the at least one DC load.

Also, the control unit may operate the switch arrangement to connect DC electrical energy produced by said PV panels that is in excess of what is required by the inverter to at least one DC load.

### BRIEF DESCRIPTION OF DIAGRAMS

The following diagrams represent only examples of how the principles of the invention may be applied and should not be regarded as comprehensive or restrictive in any way.

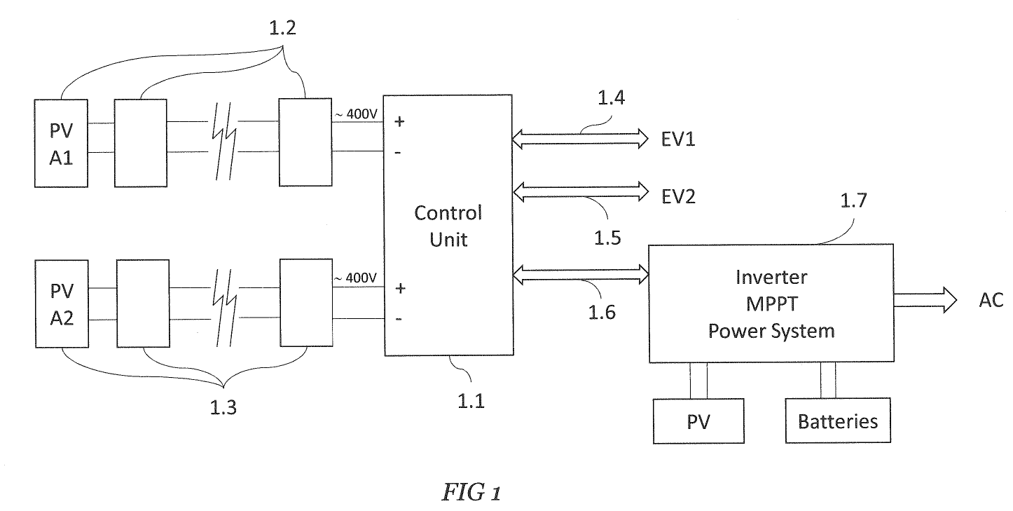

FIG. 1—System diagram with a control unit to link PV arrays with loads.

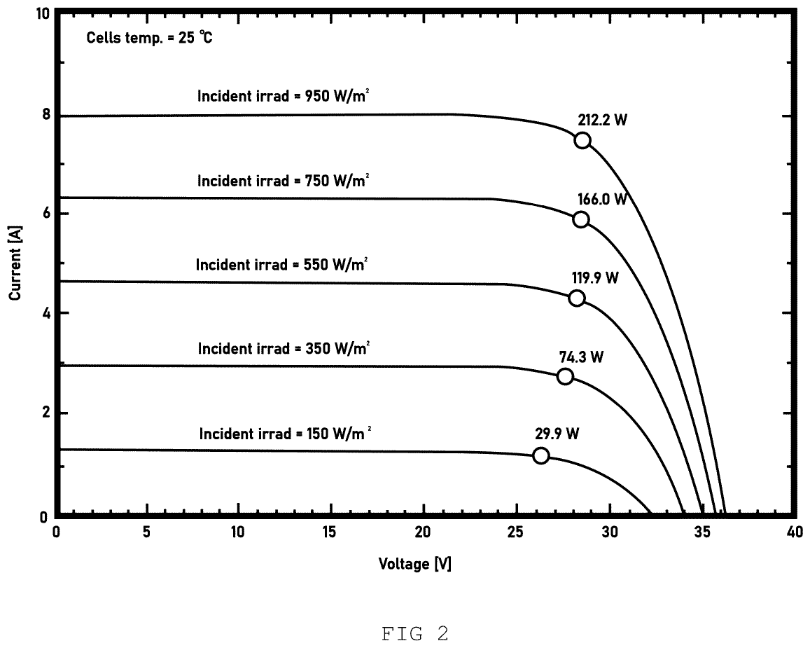

FIG. 2—Typical I-V curve for PV panels—this exemplifies a relationship between what can be expected in terms of current output and volts. This relationship varies greatly between panels, over temperature and irradiation.

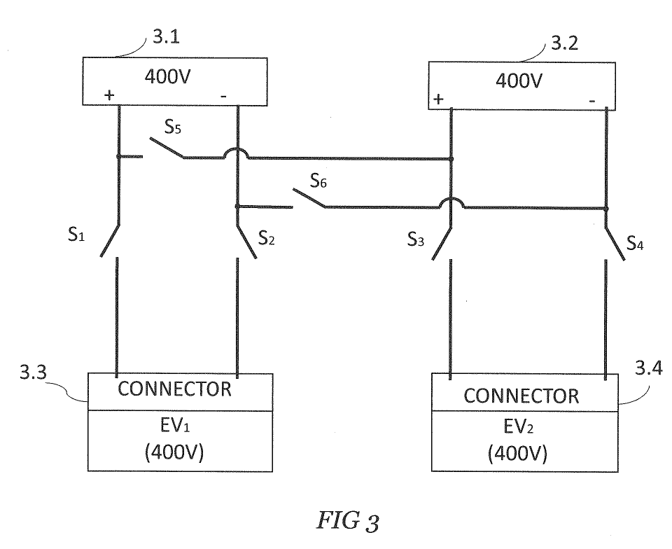

FIG. 3—An example of PV arrays and a switching configuration to connect arrays of approximately 400V PV panels to one or two EV's.

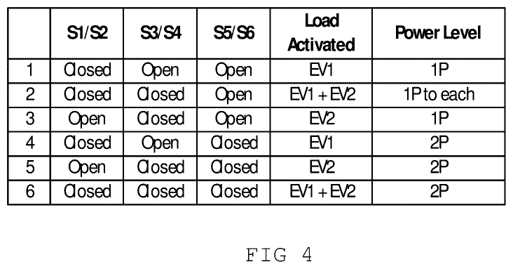

FIG. 4—A switch selection table for the configuration in FIG. 3.

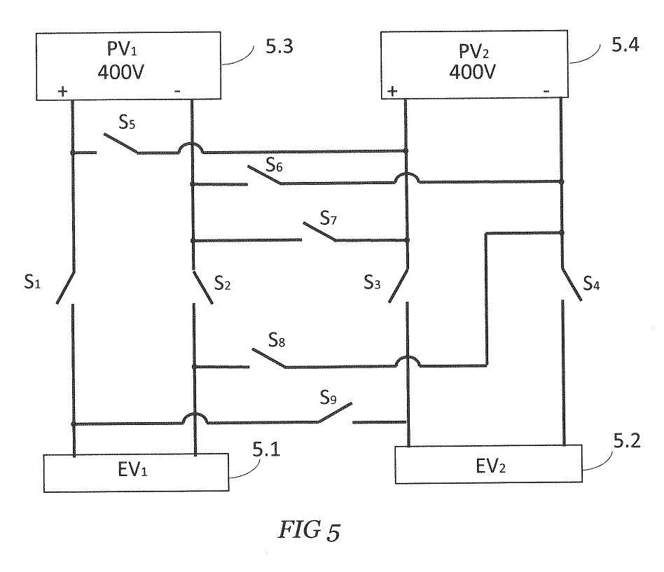

FIG. 5—An example of PV arrays and a switching system that can connect to 400V or 800V EV's.

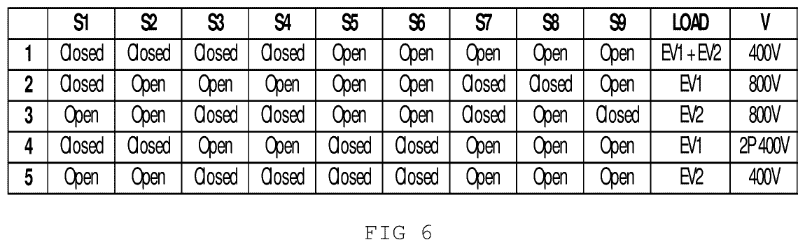

FIG. 6—A switch selection table for the example in FIG. 5.

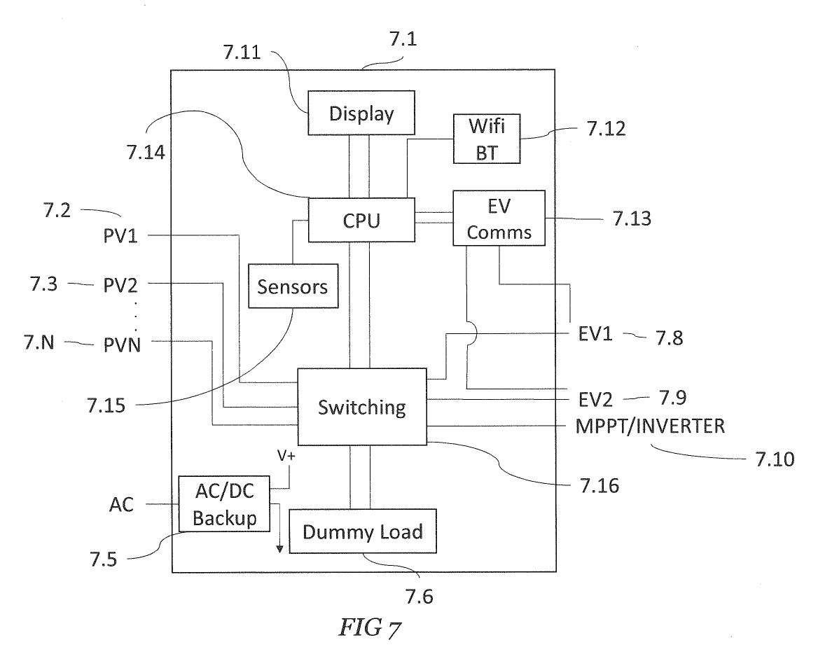

FIG. 7—A block diagram of the control unit showing essential elements to implement a charging system for EV's in accordance with this invention.

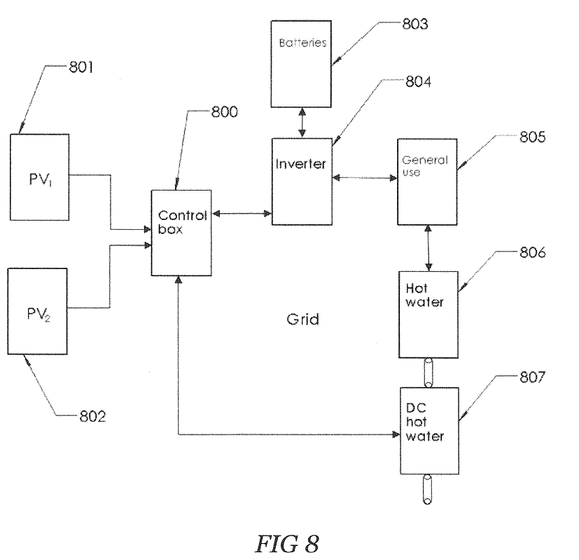

FIG. 8—A diagram for a PV water heating system.

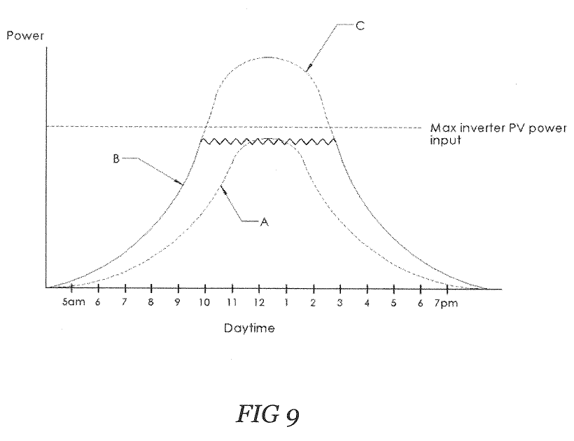

FIG. 9—PV power versus time curves for different modes of use.

### DETAILED DESCRIPTION OF THE INVENTION

The following description of examples implemented in accordance with this invention is provided to clarify and explain the invention, it is not meant to be seen as limiting. For example, in FIG. 1 two PV arrays 1.2 and 1.3 are indicated but there can be more PV arrays. Also, EV1 (1.4) and EV2 (1.5) are indicated as potential loads to be charged, but there could be more EVs.

In FIG. 1 two arrays of PV panels (1.2, 1.3) are shown. Each array is indicated to be approximately 400V. This means that sufficient individual PV panels must be connected in series to provide a voltage that at the maximum power of the panels the sum of the voltages of all the panels is higher than the EV battery voltage. In this example only EV's with a 400V battery level are considered.

The 400V designation per EV type is a loose definition in that each vehicle may differ. Also the level is not exactly 400V but may be for example 382V or 390V. The only requirement is that the voltage output from the array must be higher than the highest voltage level of the EV to be charged.

FIG. 2 is an example of the voltage output of a specific PV panel and shows that even at low levels of light the voltage per panel is above 26V or 27V. This means to get approximately 400V the design should comprise at least 15 panels in series per array. If an EV requires more than 400V then additional panels must be connected in series.

In the example of FIG. 1 the two PV arrays are connected to a control unit 1.1. There are three possible outputs, i.e. EV1 (1.4), EV2 (1.5) and the output (1.6) to a general power system 1.7, that may be an inverter with built in MPPT or a solar charger unit that charges batteries that provide power to an inverter unit to power a business or residential facility.

In accordance with this invention the control unit 1.1 can select direct DC charging any of the loads shown in FIG. 1. Specifically, if no EV is being charged the PV generated power is directed to another useful load (1,7).

FIG. 3 shows a switch configuration for two PV arrays 3.1, 3.2 each of 400V and two connectors 3.3, 3.4 for charging two 400V EV's. The control unit 1.1 can monitor if a connector (3.3, 3.4) is plugged into an EV and, based on communication between the EV and the control unit (not shown), the PV arrays 3.1, 3.2 can be switched to charge one EV (double power) or two EV's, either each being charged per a separate array, or in parallel from both PV arrays in parallel.

The switches (S1 to S6) are typically IGBT devices but MOSFET's, SCR's and relays may also be considered.

FIG. 4 shows the possible selection of the switches in FIG. 3 and the outcomes of the selections. Outcome 6 is unlikely because the EV's may not be at the same charging level.

If the PV arrays 3.1, 3.2 are connected in parallel (S5 and S6 closed) it is recommended that the control unit 1.1 connects EV1 and EV2 on a time division multiplexed (TDM) mode. This means each EV will be charged individually in a time slot, and then the other. Thus when S1/S2 are closed S3/S4 will be open and vice versa. The control unit may charge intelligently by changing the duty cycle depending on the state of charge, meaning that for example when one EV has a charge level of more than 80% and the other EV has a charge level lower than 50% the control unit may allocate more charge time to the lower charged vehicle.

FIG. 5 shows a switch configuration where one or two EV's 5.1, 5.2 can be charged at 400V or one EV can be charged at 800V from PV arrays 5.3, 5.4.

By using more switches than those shown, the arrangement in FIG. 5, this can be expanded to charge two or more EV's with 800V on a TDM basis. The duty cycle between the EV's may be fast (msec) or slow (minutes) and will depend on recommendations from the EV manufacturers and will be such as to limit losses and heat generation. If more PV panel arrays are used, more EV's can also individually be charged with 800V.

FIG. 1 is a table of selections of switches S1 to S2 in FIG. 5 and the specific outcomes based on the switch selections. This is exemplary, and non-limiting, and is only presented to convey the inventive concept.

Simplicity and low cost are the main outcomes since no DC to DC, or DC to AC, converters are required to charge an EV. To improve efficiency, the voltage at which the EV is being charged must be as close as is possible to the maximum power point voltage of the PV panel array. In an embodiment of the invention individual PV panels may be switched in or out to achieve this. Any PV panel not used may be switched to another load.

FIG. 7 shows a block diagram of key building blocks of a control unit 7.1 in accordance with this invention, which includes an optional AC connection to an AC/DC converter 7.5 in the control unit 7.1 to provide power to drive the electronics. It is not suggested to use the converter for charging the EV. Furthermore, the power must be backed up with a battery or a super capacitor to maintain operation during times of grid failure. Another option is to derive power from the PV panels, but this power will fall away at night or on rainy days. The converter is a low wattage device which is only provided to power the electronics in the control unit 7.1.

PV arrays 7.2, 7.3, 7.N are as per description above. Assuming the current standards for EV's are 400V and 800V, PV arrays of 400V each provide a flexible basis for various configurations. The voltage range required by a typical inverter MPPT port 7.10 will include 400V.

A dummy load 7.6 is used to condition the PV array voltage in order to prevent excessive voltage to be connected to a load. Since the dummy load will only be activated momentarily it will not dissipate lots of heat, and therefore does not require large components.

An EV communication unit 7.13 and a power switch unit 7.16 connect to ports for EV1 (7.8) and EV2 (7.9). The communications transfers information between the control unit 7.1 and each EV (7.8, 7.9) about states of charge, acceptable current limits, states of connection etc. The communication is in accordance with standard EV regulations and requirements. The communication between the control unit 7.1 and the EV's 7.8, 7.9 may inform the control unit 7.1 about when to switch between charging modes, if the charging current is too high for an EV, or when an EV battery is fully charged and must be disconnected from charging.

Any unused PV generated energy may be directed to the inverter/MPPT port 7.10 if available. In this way and in accordance with this invention a very low cost and efficient (DC) charging station for multiple EV's is provided with the advantage that when no EV is being charged the PV panels can be seen as part of a larger grid of PV panels feeding into a regular solar power system. This means that the EV charging does not add load to the regular power system (inverter) that provides AC (110V or 220V) to a business facility or residence. The inverse can also be implemented i.e. when the PV energy to the inverter system is more than required, it can be directed to the non-inverter (DC) usage.

If DC to AC conversion is done within the control unit, for example to charge an EV with AC, then the AC can be routed elsewhere when required.

According to this invention the switching unit 7.16 may also under certain circumstances or commands receive power from the EV ports 7.8 and 7.9 (and other ports if more than two are available) and route the power to the inverter/MPPT port 7.10 as if there are batteries feeding into the inverter. This means the EV batteries augment the regular battery storage of the inverter system.

The advantage of this invention can be explained by an example wherein a business requires 60 kW to operate its lights, computers, office equipment, air conditioners, etc. This requires a certain inverter size (for example 80 kW) with some excess above the 60 kW and sufficient batteries to cope with any grid failure such as load shedding, and cloudy skies, when PV panels are the main source. Adding 8 vehicles charging at 8 kW will require an additional 64 kW to the inverter and several stages of losses during conversion for DC to AC and from AC to DC, plus several charging stations.

To implement regular DC charging stations from the AC grid would be prohibitive in cost and infrastructure requirements.

A CPU 7.14 in the control unit 7.1 performs the necessary software functions. A display 7.11 is provided. The control unit 7.1 may comprise a WiFi/BT communications interface unit 7.12 to allow a user to interface with the control unit 7.1 and do some programming, remote control commands or setting adjustments as deemed fit. This unit may also control payments or authorization functions.

The control unit 7.1 may also be controlled, for example, from a central energy management system, to direct all PV power from PV panels or even energy from EV batteries (if the EV's have the capability to export electrical energy) to the inverter/MPPT port 7.10 under certain conditions.

The sensor unit 7.15 may include voltage sensors for the PV panel arrays to prevent discharging from an EV to the panels, temperature sensing, power sensing for reporting (or payment) purposes.

Elements like noise filters (switching, RF etc) and ESD protection are not shown. These and other aspects, for example, an ON/OFF switch fall outside the scope of this invention as these aspects are regarded as state of the art knowledge.

FIG. 8 is a block diagram of a configuration with PV panels 801, 802, a control box 800, an inverter system 804, battery storage 803, general AC usage 805, and water heaters 806, 807.

The control box 800 comprises a key component that makes the implementation possible; all other elements can be standard off the shelf items. The PV panels 801, 802 can be seen as two groups with a first group being PV1 (801), for example, the maximum number of PV panels that can be connected to the inverter 804 (typically a MPPT input) and still be within the inverter specification. A second group being PV2 (802) can then be additional panels that are sub selectable in small numbers or as a whole, when the PV power supply goes above the inverter specification.

The control box 800 is used to direct the PV power to the inverter 804 or to the heating elements of the DC water heater 807.

Energy from the inverter 804 can also be stored in the batteries 803 for use when demand exceeds the PV supply, or for example at night.

The water heating can be effected by two units like a normal AC (grid) water heater (geyser) 806 and a DC powered water heater and reservoir 807. In the configuration shown the DC water heater 807 is used to feed the AC (normal) water heater 806. In another configuration the two water heaters may be combined with two heating elements for AC and DC power.

The AC water heater 806 may be on a timer (not shown) to limit energy usage at night. But as the hot water in the heater 806 is used it is replenished with hot water from the DC water heater 807. In another embodiment the DC water heater 807 has a much bigger volume (say for a hotel or a large house) and feeds into multiple distributed smaller water heaters 806 (only one is shown). This would ensure there is always hot water but energy from the inverter or grid is only used when the water temperature in the DC water heater 807 becomes low at the outlet point.

FIG. 9 shows the effect. A power curve A is an example of what normally happens with a PV and inverter combination. The curve A must always stay below the inverter maximum input level. The curve does depend on the geographic location but the principle is clear. When the sun is at an angle in the morning or late afternoon, the radiation levels are low (see also FIG. 2) and the PV energy output is low. But residential energy use is normally high in the morning and early evening. The curve B, where more panels are fitted, reaches the maximum inverter input more rapidly, which is beneficial and also stays on it for longer before it tapers off in the afternoon. The wave pattern is an example of the control box 800 switching PV panels over from the inverter 804 to the DC water heater 807. In a simplistic solution the control box 800 can also switch over the second group PV2 (802) in one step.

The curve C shows the total PV input as a function of time if the control box 800 does not switch the PV panels over. It is also possible for the system to provide information to the control box to switch more panels to the water heater (or non-inverter usage) should this be beneficial.

On a rainy day or with cloud reduced radiation the system can be operated with more panels connected to the inverter system.

1. A method of generating direct current (DC) energy for at least one DC load by using at least one array of PV panels that are connected to a control unit comprising a switch arrangement, including the step of using the control unit to configure the PV panels to generate a DC voltage and current output which is supplied to the at least one DC load, without requiring DC to DC (switch mode) converters or DC to AC converters in said control unit or in a circuit connected to the at least one DC load.

2. A method according to claim 1 wherein the at least one DC electrical load is selected from the following: a battery arrangement in an electric vehicle, respective battery arrangements in multiple electric vehicles, a water heating element and multiple water heating elements.

3. A method according to claim 2 wherein energy from the PV panels is used to charge a battery arrangement in at least one electric vehicle and the method includes the step of using the control unit to configure the PV panels in an array to produce said energy to meet the voltage and current requirements for charging a connected electric vehicle.

4. A method according to claim 1 wherein the control unit is also connected to an normal inverter input (MPPT) and wherein the method includes the step of dynamically switching the PV panels in a configuration to provide maximum power to the inverter based on the inverter specification, and to switch the PV panels with excess energy supply, disconnected from the inverter at any time, to the at least one DC load.

5. A method according to claim 4 which includes the step of using the control unit to operate the switch arrangement to connect DC electrical energy produced by said PV panels that is in excess of what is required by the inverter, to the at least one DC load.

6. A method according to claim 5 wherein energy generated by the PV panels is used to power at least one water heating element and the method includes the step of using the control unit to operate the switch arrangement to configure at least one array of the PV panels, that meets the voltage and current requirements for powering the said at least one water heating element.

7. Apparatus for generating direct current (DC) electrical power comprising at least one array of PV panels, a control unit and a switch arrangement connected to the PV panels and wherein the control unit is actuable to control the switch arrangement to configure the PV panels to control the DC voltage and current output from the PV panels, which output is connected to at least one DC electrical load, without requiring switch mode DC to DC or DC to AC converters in the control unit or in a circuit which is connected to the at least one DC load.

8. Apparatus according to claim 7 wherein the at least one DC electrical load is selected from the following: a battery arrangement in an electric vehicle, respective battery arrangements in multiple electric vehicles, a water heating element and multiple water heating elements.

9. Apparatus according to claim 7 which includes an inverter and wherein the control unit is also connected to a normal inverter input (MPPT) and the control unit is actuable to control the switch arrangement to dynamically switch the PV panels in configurations to provide maximum power to the inverter, based on the inverter specification, and to disconnect the energy supply to the inverter at any time, and to switch the PV panels with excess energy supply to power the at least one DC load.

10. Apparatus according to claim 7 wherein the PV generated DC energy is used to charge a battery arrangement in at least one electric vehicle, and wherein the control unit is used to configure the PV panels in an array, that meets the voltage and current requirements for charging an electric vehicle which is connected to the switch arrangement.

11. Apparatus according to claim 8 wherein the control unit is operable to configure the switch arrangement so that the PV generated DC power is operable to charge battery arrangements in at least two respective electrical vehicles in parallel, or alternately.

12. Apparatus according to claim 9 wherein the control unit operates the switch arrangement to connect DC electrical energy produced by said PV panels that is in excess of what is required by the inverter, to at least one DC load.
